(19) United States
(12) Patent Application Publication
(10) Pub. No.: US 2006/0210159 A1
(43) Pub. Date: Sep. 21, 2006

(54) Foreground extraction approach by using color and local structure information

(76) Inventors: Yea-Shuan Huang, Hsinchu (TW); Hao-Ying Cheng, Hsinchu (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 11/079,212

(22) Filed: Mar. 15, 2005

(51) Int. Cl. G06K 9/34

(52) U.S. Cl. 382/173

(57) ABSTRACT

A method for extracting a foreground object from an image comprises selecting a first pixel of the image, selecting a set of second pixels of the image associated with the first pixel, determining a set of contrasts for the first pixel by comparing the first pixel with each of the second pixels in image value, and determining an image structure of the first pixel in accordance with the set of contrasts.

### BACKGROUND

1. Field of the Invention

The present invention relates generally to video surveillance, and, in particular, to a method for extracting a foreground object from a background image.

2. Background of the Invention

Over the past decades, closed-loop video monitoring systems have been generally used for security purposes. However, these systems are typically limited to recording images in places of interest, and do not support analysis of suspicious objects or events. With the development and advancement in digital video and automatic intelligence techniques, intelligent monitoring systems based on computer vision have become popular in the security field. For example, intelligent video surveillance systems are typically deployed in airports, metro stations, and banks or hotels for identifying terrorists or crime suspects. An intelligent monitoring system refers to one that automatically analyzes images taken by cameras without manual operation for identifying and tracking moving objects such as people, vehicles, animals or articles. In analyzing the images, it is typically necessary to distinguish a foreground object from a background image to enable further analysis of the foreground object.

Conventional techniques for extracting foreground objects may include background subtraction, temporal differencing and optical flow. The background subtraction approach includes a learning phase and a testing phase. During the learning phase, a plurality of pictures free of foreground objects are collected and used as a basis to establish a background model. Pixels of the background model are generally described in a simple Gaussian Model or Gaussian Mixture Model. In general, a smaller Gaussian model value is assigned to a pixel that exhibits a greater difference in color or grayscale level from the background image, while a greater Gaussian model value is assigned to a pixel that exhibits a smaller difference in color or grayscale level from the background image. An example of the background subtraction approach can be found in R. T. Collins et al., “A System for Video Surveillance and Monitoring,” Tech. Rep., The Robotics Institute, Carnegie Mellon University, 2000. The background subtraction approach may have disadvantages in extracting a foreground object that has a color closer to that of a background. Moreover, a shadow may be incorrectly determined as a foreground object. Consequently, the resultant picture extracted may be relatively broken and even unrecognizable.

The temporal differencing approach directly subtracts pictures taken at different time points. A pixel is determined as a foreground pixel that belongs to a foreground object if the absolute value of a difference between the pictures exceeds a threshold. Otherwise, the pixel is determined as a background pixel. An example of the temporal differencing approach can be found in C. Anderson et al, “Change Detection and Tracking Using Pyramid Transformation Techniques,” In Proc. of SPIE Intelligent Robics and Computer Vision, Vol. 579, pp. 72-78, 1985. The temporal differencing approach may have disadvantages in extracting a foreground object that is immobilized or moves slowly across a background. In general, local areas having boundaries or lines of a foreground object can be easily extracted. Block images of a foreground object without significant change in color, for example, close-up clothing, pants or faces, however, may be incorrectly determined as background images.

The optical flow approach, based on the theory that optical flow changes when a foreground object moves into a background, calculates the amount of displacement between frames for each pixel of an image of a moving object, and determines the position of the moving object. An example of the optical flow approach can be found in U.S. Published Patent Application No. 20040156530 by T. Brodsky et al., “Linking Tracked Objects that Undergo Temporary Occlusion.” The optical flow approach involves a relatively high amount of computation and therefore may not support a real-time image processing due to speed limitations.

### BRIEF SUMMARY OF THE INVENTION

The present invention is directed to methods that obviate one or more problems resulting from the limitations and disadvantages of the prior art.

In accordance with an embodiment of the present invention, there is provided a method for extracting a foreground object from an image that comprises selecting a first pixel of the image, selecting a set of second pixels of the image associated with the first pixel, determining a set of contrasts for the first pixel by comparing the first pixel with each of the second pixels in image value, and determining an image structure of the first pixel in accordance with the set of contrasts.

Also in accordance with the present invention, there is provided a method for extracting a foreground object from an image that comprises selecting a first pixel of the image, selecting at least one set of second pixels of the image associated with the first pixel, determining at least one set of contrasts for the first pixel by comparing the first pixel with each of that at least one set of second pixels in image value, and determining at least one image structure of the first pixel in accordance with the at least one set of contrasts.

Further in accordance with the present invention, there is provided a method for extracting a foreground object from an image that comprises collecting a series of images to serve as background images, determining an image value of a pixel at a same position of each of the series of images, determining a model for correlating the image value of the pixel with the background images, determining a set of contrasts for the pixel by comparing the pixel with a set of pixels in image value, and determining at least one set of image structures of the pixel in accordance with the set of contrasts.

Still in accordance with the present invention, there is provided a method for extracting a foreground object from an image that comprises collecting a series of images to serve as background images, determining a pixel at a same position of each of the series of images, determining a set of contrasts for the pixel by comparing the pixel with a set of pixels in image value, determining at least one set of image structures of the pixel in accordance with the set of contrasts, and determining a model for correlating the at least one set of image structures with the background images.

Yet still in accordance with the present invention, there is provided a method for extracting a foreground object from an image that comprises collecting a series of images to serve as background images, determining an image value of a pixel at a same position of each of the series of images, determining a first model for correlating the image value of the pixel with the background images, determining a set of contrasts for the pixel by comparing the pixel with a set of pixels in image value, determining at least one set of image structures of the pixel in accordance with the set of contrasts, and determining a second model for correlating the at least one set of image structures with the background images.

Further still with the present invention, there is provided a method for extracting a foreground object from an image that comprises collecting a series of images to serve as background images, determining a first model for correlating an image value of a pixel with one of the background images, determining a set of contrasts for the pixel by comparing the pixel with a set of neighboring pixels in image value, determining at least one set of image structure values of the pixel in accordance with the set of contrasts, determining a second model for correlating the at least one set of image structure values with one of the background images, selecting a pixel of interest having an image value and a set of image structure values, calculating a first probability based on the image value of the pixel of interest and the first model, and calculating a second probability based on the set of image structure values of the pixel of interest and the second model.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the present invention and together with the description, serves to explain the principles of the invention.

### BRIEF DESCRIPTION OF THE DRAWINGS

Reference will now be made in detail to the present embodiment of the invention, an example of which is illustrated in the accompanying drawings. Wherever possible, the same reference numbers are used throughout the drawings to refer to the same or like parts.

FIG. 1 is a diagram illustrating a method for extracting a foreground object from an image in accordance with one embodiment of the present invention;

FIG. 2A illustrates an example of the method shown in FIG. 1 for determining an image structure;

FIG. 2B illustrates another example of the method shown in FIG. 1 for determining an image structure;

FIG. 3 is a diagram illustrating a method for extracting a foreground object from an image in accordance with one embodiment of the present invention; and

FIG. 4 illustrates a comparison of experimental results between conventional methods and a method in accordance with one embodiment of the present invention.

### DETAILED DESCRIPTION OF THE INVENTION

The present invention provides a method for extracting a foreground object from an image using local image structure information and image color information.

A. Image Structure:

Supposing that x is a pixel of an image, according to the optical imaging principle, an image value including the color or grayscale level of x, I(x), can be expressed as follows:
I(x)=R(x)·L(x)

where R(x) represents a reflectance vector of the pixel x, and L(x) represents an illumination vector of the pixel x.

Likewise, for a neighboring pixel y, its image value I(y) can be expressed as follows:
I(y)=R(y)·L(x)

where R(y) represents a reflectance vector of the pixel y, and L(y) represents an illumination vector of the pixel y.

Given the above, the relationship between I(x) and I(y) is expressed below.

$$\frac{I ( x )}{I ( y )} = \frac{R ( x ) \cdot L ( x )}{R ( y ) \cdot L ( y )}$$

Since the pixel x neighbors with the pixel y, it can be assumed that their illumination vectors are close to or equal to one another, i.e., L(x)≈L(y). The relationship between I(x) and I(y) can therefore be expressed below.

$$\frac{I ( x )}{I ( y )} = \frac{R ( x )}{R ( y )}$$

In practice, however, in addition to the factor of illumination change, other factors may affect the image value of a pixel. Therefore, the above-mentioned relationship is not directly used to describe the color relationship between the pixels x and y. Instead, in accordance with one embodiment of the present invention, a contrast between the pixels x and y is determined by an operator defined below.

$$ζ ( I ( x ) , I ( y ) ) = \{ \begin{matrix}0 , & if I ( x ) \geq I ( y ) ; \\ 1 , & otherwise .\end{matrix}$$

For a set of pixels associated with the pixel x, for example, Φ(x)={P₀, P₁ . . . Pₙ}, which neighbors with the pixel x, each of the set of pixels P₀, P₁ . . . Pₙ is compared with the pixel x in image value, resulting in a set of contrasts. The set of contrasts includes “texture” information regarding the pixel x and its neighboring pixels in a local area of an image. An image structure Γ(x) is defined below to express the texture information.

$$Γ ( x ) = {\sum }_{i = 0 , {p}_{i} ∈ Φ ( x )}^{n} {2}^{i} \times ζ ( I ( {p}_{i} ) , I ( x ) ) .$$

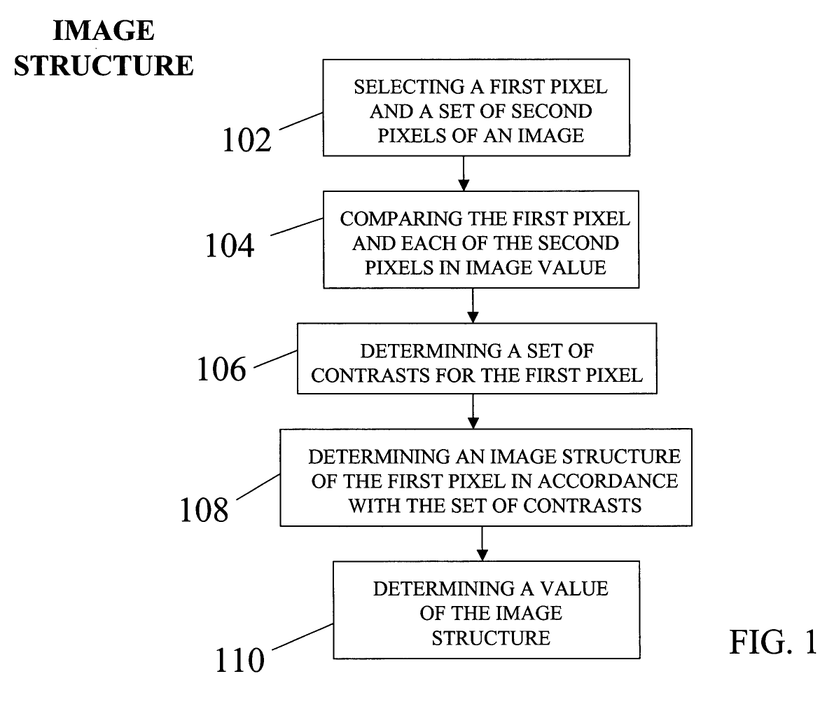

To summarize, FIG. 1 is a diagram illustrating a method for extracting a foreground object from an image in accordance with one embodiment of the present invention. Referring to FIG. 1, at step 102, a first pixel of interest and a set of second pixels associated with the first pixel are selected from an image. At step 104, the first pixel and each of the second pixels are compared in image value. Next, at step 106, a set of contrasts is determined as a result of the comparison. An image structure of the first pixel is determined in accordance with the set of contrasts at step 108. Then, at step 110, a value of the image structure is determined.

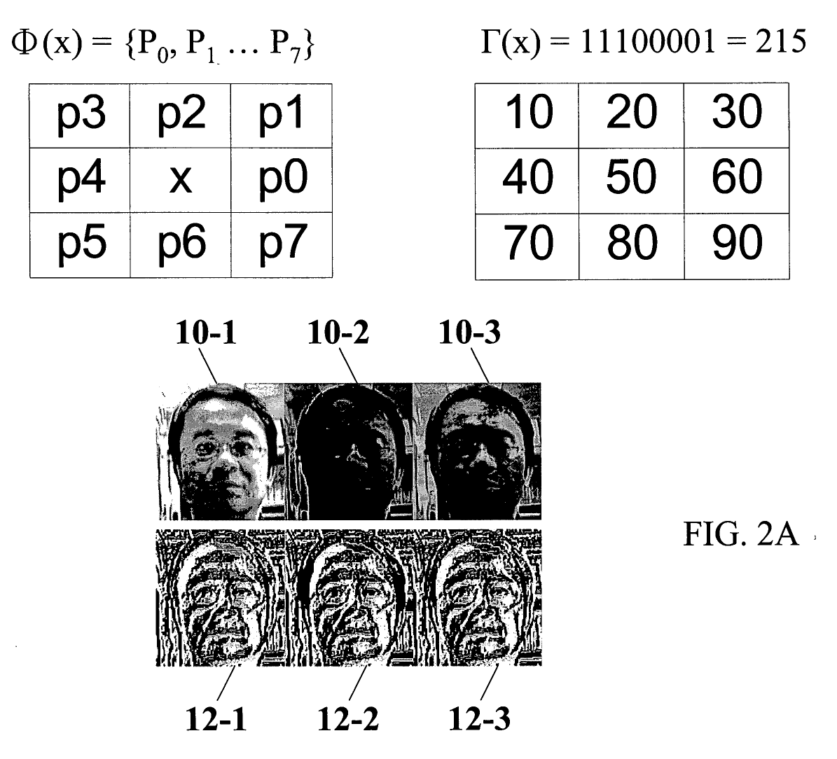

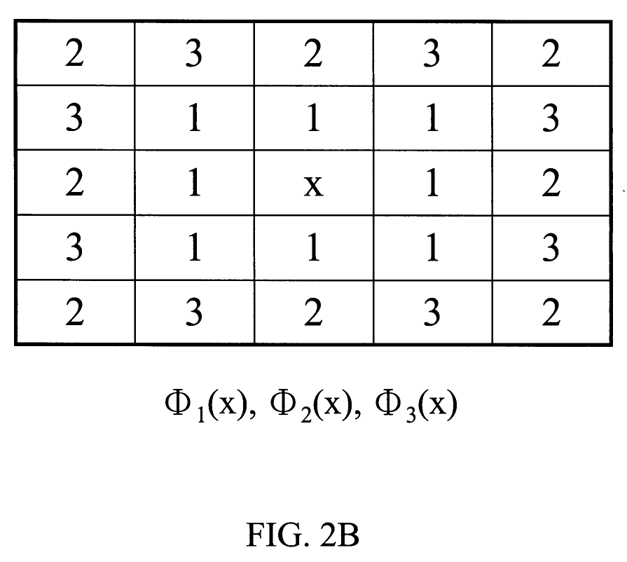

FIG. 2A illustrates an example of the method shown in FIG. 1 for determining an image structure. Referring to FIG. 2A, for a pixel x of an image 10-1, 10-2 or 10-3, a set of pixels P₀, P₁ . . . P₇ is selected. Each of the pixels x and the set of pixels P₀, P₁ . . . P₇ has an image value. The image value includes a color level containing, for example, R (red), G (green) and B (blue) intensity values each ranging from 0 to 255, or a grayscale level ranging from 0 to 255, given an 8-bit resolution. For example, the image values of the pixels x, P₀ and P₇ are 50, 60 and 90, respectively. Each of the pixels P₀, P₁ . . . P₇ is compared with the pixel x in image value to determine an image structure for the pixel x. For example, since the image value of P₇, 90, is greater than that of the pixel x, 50, a binary value, 1, is determined as the most significant bit of an image structure Γ(x). Similarly, since the image value of P₁, 30, is smaller than that of the pixel x, 50, a binary value, 0, is determined as the second least significant bit of the image structure Γ(x). As a result, the image structure Γ(x) (=11100001) and an image structure value, 215, are determined.

Images 10-1, 10-2 and 10-3 are substantially the same except their illumination levels. Images 12-1, 12-2 and 12-3 are the results of processing images 10-1, 10-2 and 10-3, respectively, with the method according to the present invention.

Although illumination levels of images 10-1, 10-2 and 10-3 are different, the resultant images 12-1, 12-2, 12-3 have substantially the same textures.

FIG. 2B illustrates another example of the method shown in FIG. 1 for determining an image structure. Referring to FIG. 2B, a plurality of sets of pixels Φ₁(x), Φ₂(x) and Φ₃(x) are selected to provide the texture information of the pixel x. Φ₁(x) includes 8 (eight) pixels labeled “1” in a 5×5 area with the pixel x at the center. Similarly, Φ₂(x) and Φ₃(x) includes 8 pixels labeled “2” and “3”, respectively. Accordingly, a plurality of image structures Γ₁(x), Γ₂(x) and Γ₃(x) corresponding to the sets of pixels Φ₁(x), Φ₂(x) and Φ₃(x) are determined. Each of the image structures Γ₁(x), Γ₂(x) and Γ₃(x) can be expressed in a byte due to the corresponding 8-pixel Φ₁(x), Φ₂(x) and Φ₃(x).

B. Extraction of a Foreground Object:

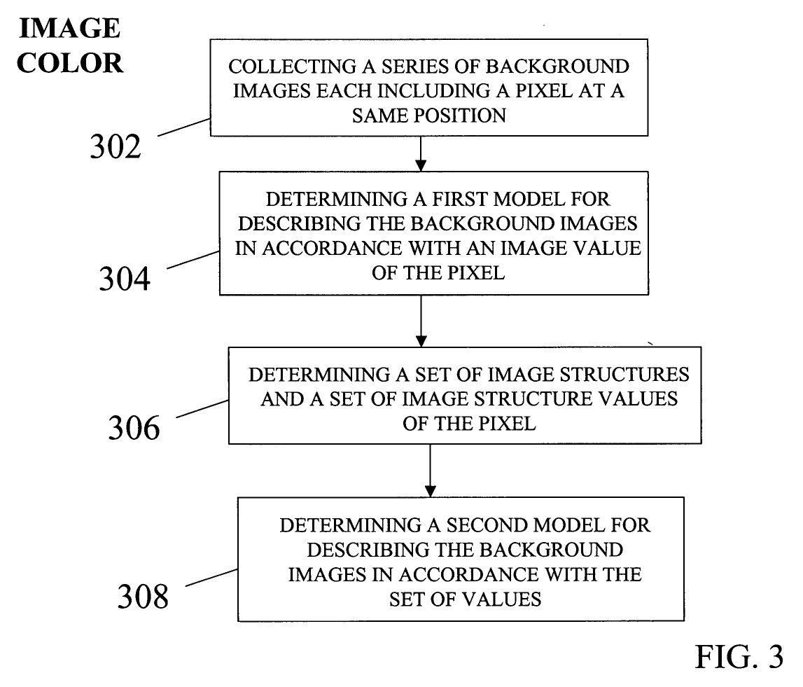

To extract a foreground object from a background image, the background image must be predetermined to serve as a comparison basis for the foreground object. FIG. 3 is a diagram illustrating a method for extracting a foreground object from an image in accordance with one embodiment of the present invention. Referring to FIG. 3, at step 302, a series of images, for example, a number of M images, M being an integer, are collected. Each of the M images includes a pixel z in a same position of these images. Each of the pixels z of the M images has an image value, for example, f₁, f₂ . . . f_{M}, respectively.

At step 304, a first model λ for describing a background image is determined in accordance with the image value of the pixel z. In one embodiment according to the present invention, the first model λ includes a Gaussian Mixture Model given below.
λ={pᵢ,\vec{u}ᵢ,Σᵢ},i=1, 2, . . . , C

where p represents a mixture weight, \vec{u} represents a mean vector, Σ represents a covariance matrix, and C represents a mixture number.

The above-mentioned parameters are governed by the following equations.

$${\sum }_{k = 1}^{c} {p}_{k} = 1$$

$${p}_{i} = \frac{1}{M} {\sum }_{j = 1}^{M} p ( i \text{\vert} {f}_{j} , λ )$$

$${μ}_{i} = \frac{{\sum }_{j = 1}^{M} p ( i \text{\vert} {f}_{j} , λ ) {f}_{j}}{{\sum }_{j = 1}^{M} p ( i \text{\vert} {f}_{j} , λ )}$$

$${σ}_{i}^{2} = \frac{{\sum }_{j = 1}^{M} p ( i \text{\vert} {f}_{j} , λ ) {f}_{j}^{2}}{{\sum }_{j = 1}^{M} p ( i \text{\vert} {f}_{j} , λ )} - {\overline{μ}}_{i}^{2}$$

(where σᵢ represents an i-th element on the diagonal of the covariance matrix)

$$p ( i \text{\vert} z , λ ) = \frac{{p}_{i} {b}_{i} ( z )}{{\sum }_{j = 1}^{C} {p}_{j} {b}_{j} ( z )} , and$$

$${b}_{i} ( z ) = \frac{1}{{( 2 π )}^{NW / 2} {\vert {\sum }_{i} \vert}^{1 / 2}} exp \{ - \frac{1}{2} {( z - {μ}_{i} )}^{′} {\sum }_{i}^{- 1} ( z , {μ}_{i} ) \}$$

The first model λ determined at step 304 therefore determines the probability of the image value fⱼ of the pixel z. Next, at step 306, given m sets of contrasts Φ₁(z), Φ₂(Z) . . . Φₘ(Z) for the pixel z, a set of corresponding image structures Γ₁(z), Γ₂(z) . . . Γ_{M}(z) and in turn their values are determined. Since the color of an image may change due to noise or unstable illumination, each of the set of contrasts Φ₁(z), Φ₂(Z) . . . Φₘ(z) may have several image structures. For example, a contrast Φⱼ(z) for the pixel z may have a number of r different image structure values Γⱼ₁, Γⱼ₂ . . . Γⱼᵣ instead of Γⱼ alone. At step 308, a second model Sⱼ(z), which represents a statistical operation for the contrast Φⱼ(z), is determined.
Sⱼ(z)={(Γⱼᵢ, πⱼᵢ)|1≦i≦r, and πⱼᵢ≧πⱼᵢ₊₁≧0 }

where πⱼᵢ represents the probability of Γⱼᵢ, which observes

$${\sum }_{i = 1}^{r} {π}_{ji} = 1.$$

For the number of m sets of contrast, there are a number of m such second models S₁, S₂ . . . and Sₘ. In view of the above, the first model λ describes a background pixel by its color information, and the second model S describes a background pixel by its image structure information.

Given a pixel H of interest having an image value of F and a set of image structures T(={t₁, t₂ . . . tₘ}), where tⱼ represents an image structure value for a contrast Φⱼ(H), the likelihood that the pixel H is a background pixel is determined below.

$$LK ( F , T \text{\vert} λ , {S}_{1} , … , {S}_{m} ) = p ( F \text{\vert} λ ) + {w}^{*} {\sum }_{j = 1}^{m} ( 1 - \frac{G ( {S}_{j} , {t}_{j} )}{{n}_{j}} )$$

where w represents a weight, and nⱼ represents the number of pixels defined by Φⱼ(H),

where

$$p ( F \text{\vert} λ ) = {\sum }_{i = 1}^{C} {p}_{i} {b}_{i} ( F ) ,$$

governed by the first model λ, determines the probability of the pixel H with the color F being a background color, and

where

$$G ( {S}_{j} , {t}_{j} ) = {{min}^{r}}_{i = 1} BitCount ( {Γ}_{ji} ⊕ {t}_{j} ) ,$$

governed by the second model S, determines the probability of the pixel H with the image structure value tⱼ being a background pixel, the symbol ⊕ being a bit exclusive-or operation, and the function BitCount (q) determining the number of non-zero bits in a variant q. Through the logical exclusive-or operation, if any one of the image structure values Γⱼᵢ (i ranging from 1 to r) of a background pixel equals the image structure value tⱼ of the pixel H, the BitCount (q) value is zero, resulting in an increase in the

$${\sum }_{j = 1}^{m} ( 1 - \frac{G ( {S}_{j} , {t}_{j} )}{{n}_{j}} )$$

factor and in turn the likelihood of being a background pixel. On the contrary, if all of the image structure values Γⱼᵢ of a background pixel differ considerably from the image structure value tⱼ of the pixel H, a BitCount (q) value greater than zero is obtained, resulting in a decrease in the

$${\sum }_{j = 1}^{m} ( 1 - \frac{G ( {S}_{j} , {t}_{j} )}{{n}_{j}} )$$

factor and in turn the likelihood of being a background pixel.

In one aspect, a first threshold (thresh 1) is applied to the G(Sⱼ, tⱼ) calculation such that only image structure values greater than the first threshold are acceptable. Image structure values smaller than the first threshold may very likely result from noises, which may adversely affect the extraction and therefore are undesirable. The first threshold facilitates a more efficient use of the calculation source. The G(Sⱼ, tⱼ) with the first threshold is defined below.

$$G ( {S}_{j} , {t}_{j} ) = {{min}_{i = 1}}^{{r}^{′}} BitCount ( {Γ}_{ji} ⊕ {t}_{j} ) ,$$

where πⱼᵢ≧thresh1

where r′ represents the number of πⱼᵢ being greater than the first threshold.

A second threshold (thresh 2) is applied to the LK(F,T|λ,S₁, . . . , Sₘ) calculation to extract a foreground object from a background image, as given below.

$$D ( x ) = \{ \begin{matrix} 0 , when LK ( f , T \vert λ , {S}_{1} , … , {S}_{m} ) \geq thresh 2 ; \\ 1 , otherwise .\end{matrix}$$

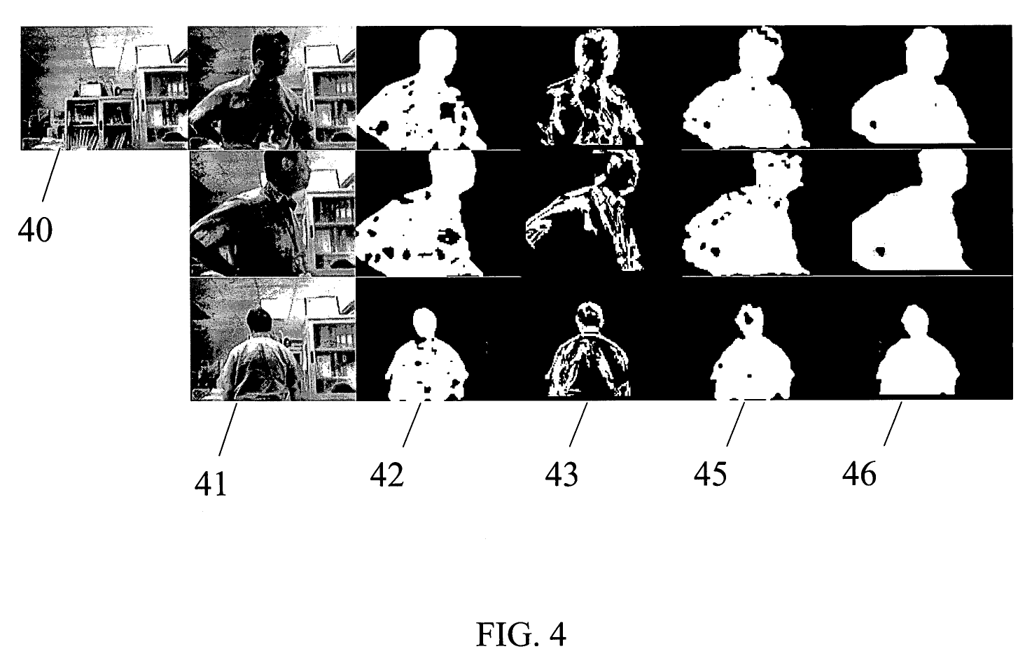

FIG. 4 illustrates a comparison of experiment results between conventional methods a method in accordance with one embodiment of the present invention.

Referring to FIG. 4, a series of pictures 40 of an office free of any foreground objects are taken to serve as background images. Three sets of contrasts Φ₁, Φ₂ and Φ₃ are determined. Each of the sets of contrasts includes eight pixels, which facilitate expressing its corresponding image structure Γⱼᵢ in one byte. The first threshold is approximately 0.1, the second threshold is approximately 0.5, and the weight is approximately 0.3. The values of r and r′ are approximately 4.2 and 2.6, respectively. Pictures 41 containing a foreground object with the office in the background serve as a test set of images. Images 42 are test results of a conventional background subtraction approach based on color information. Images 43 are test results of a conventional temporal differencing approach based on color information. Images 45 are test results of a background subtraction approach based on image structure information. Images 46 are test results of a background subtraction approach based on both color information and image structure information. Among the experimental results, images 42, 43 and 44 may be relatively tattered or broken as compared to images 46 obtained in accordance with a method of the present invention.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for extracting a foreground object from an image, comprising:
selecting a first pixel of the image;
selecting a set of second pixels of the image associated with the first pixel;
determining a set of contrasts for the first pixel by comparing the first pixel with each of the second pixels in image value; and
determining an image structure of the first pixel in accordance with the set of contrasts.

2. The method of claim 1, further comprising selecting at least one set of second pixels of the image associated with the first pixel.

3. The method of claim 1, further comprising determining at least one set of contrasts for the first pixel.

4. The method of claim 1, further comprising determining at least one image structure of the first pixel.

5. The method of claim 1, further comprising determining a value of the image structure.

6. The method of claim 1, further comprising determining the set of contrasts for the first pixel by an operator:
$$ζ ( I ( x ) , I ( y ) ) = \{ \begin{matrix} 0 , if I ( x ) \geq I ( y ) ; \\ 1 , otherwise .\end{matrix}$$
where I(x) is an image value of a first pixel x, and I(y) is an image value of one of second pixels y.

7. The method of claim 6, further comprising determining the image structure of the first pixel by:
$$Γ ( x ) = {\sum }_{i = 0 , {p}_{i} ∈ Φ ( x )}^{n} {2}^{i} \times ζ ( I ( {p}_{i} ) , I ( x ) ) .$$
where Γ(x) is an image structure of the first pixel x, and Φ(x) is a set of pixels associated with the first pixel x, Φ(x)={P₀, P₁ . . . Pₙ}, n being an integer.

8. A method for extracting a foreground object from an image, comprising:
selecting a first pixel of the image;
selecting at least one set of second pixels of the image associated with the first pixel;
determining at least one set of contrasts for the first pixel by comparing the first pixel with each of that at least one set of second pixels in image value; and
determining at least one image structure of the first pixel in accordance with the at least one set of contrasts.

9. The method of claim 8, further comprising assigning eight pixels to one of the at least one set of second pixels.

10. A method for extracting a foreground object from an image, comprising:
collecting a series of images to serve as background images;
determining an image value of a pixel at a same position of each of the series of images;
determining a model for correlating the image value of the pixel with the background images;
determining a set of contrasts for the pixel by comparing the pixel with a set of pixels in image value; and
determining at least one set of image structures of the pixel in accordance with the set of contrasts.

11. The method of claim 10, further comprising determining a value of each of the at least one set of image structures.

12. The method of claim 11, further comprising determining another model for correlating the value of each of the at least one set of image structures with the background images.

13. The method of claim 10, further comprising correlating the image value of the pixel with the background images by a model:
λ={pᵢ,\vec{u}ᵢΣᵢ},i=1, 2, . . . , C
where p is a mixture weight, \vec{u} is a mean vector, Σis a covariance matrix, and C is a mixture number.

14. The method of claim 12, further comprising correlating the value of each of the at least one set of image structures with the background images by a model:
Sⱼ(z)={(Γⱼᵢ, πⱼᵢ)|1≦i≦r, and πⱼᵢ≧πⱼᵢ₊₁≧0}
where Sⱼ(z) is a statistical operation for a contrast Φⱼ(z) for a pixel z, Γⱼᵢ is one of r image structure values of the contrast Φⱼ(z), r being an integer, and πⱼᵢ is the probability of Γⱼᵢ, which observes
$${\sum }_{i = 1}^{r} {π}_{ji} = 1.$$

15. A method for extracting a foreground object from an image, comprising:
collecting a series of images to serve as background images;
determining a pixel at a same position of each of the series of images;
determining a set of contrasts for the pixel by comparing the pixel with a set of pixels in image value;
determining at least one set of image structures of the pixel in accordance with the set of contrasts; and
determining a model for correlating the at least one set of image structures with the background images.

16. The method of claim 15, further comprising determining another model for correlating the image value of the pixel with the background images.

17. A method for extracting a foreground object from an image, comprising:
collecting a series of images to serve as background images;
determining an image value of a pixel at a same position of each of the series of images;
determining a first model for correlating the image value of the pixel with the background images;
determining a set of contrasts for the pixel by comparing the pixel with a set of pixels in image value;
determining at least one set of image structures of the pixel in accordance with the set of contrasts; and
determining a second model for correlating the at least one set of image structures with the background images.

18. The method of claim 17, further comprising:
selecting a pixel of interest having an image level; and
determining whether the image value of the pixel of interest correlates with one of the background images.

19. The method of claim 17, further comprising:
selecting a pixel of interest;
determining a set of image structures of the pixel of interest; and
determining whether one of the set of image structures of the pixel of interest correlates with one of the background images.

20. The method of claim 17, further comprising:
selecting a pixel of interest having an image value; and
calculating the probability of the pixel of interest with the image value being a pixel of the background images.

21. The method of claim 17, further comprising:
selecting a pixel of interest;
determining a set of image structures of the pixel of interest; and
calculating the probability of the pixel of interest with the set of image structures being a pixel of the background images.

22. The method of claim 21, further comprising applying a threshold in calculating the probability of the pixel of interest.

23. The method of claim 17, further comprising expressing the first model in a Gaussian Mixture Model.

24. The method of claim 21, further comprising performing a logical exclusive-or operation in calculating the probability of the pixel of interest.

25. A method for extracting a foreground object from an image, comprising:
collecting a series of images to serve as background images;
determining a first model for correlating an image value of a pixel with one of the background images;
determining a set of contrasts for the pixel by comparing the pixel with a set of neighboring pixels in image value;
determining at least one set of image structure values of the pixel in accordance with the set of contrasts;
determining a second model for correlating the at least one set of image structure values with one of the background images;
selecting a pixel of interest having an image value and a set of image structure values;
calculating a first probability based on the image value of the pixel of interest and the first model; and
calculating a second probability based on the set of image structure values of the pixel of interest and the second model.

26. The method of claim 25, further comprising assigning a weight to one of the first probability or second probability.

27. The method of claim 25, further comprising:
adding the first probability and the second probability to form a sum probability; and
determining the pixel of interest as a pixel of the background images if the sum probability is greater than a threshold.

28. The method of claim 25, further comprising:
adding the first probability and the second probability to form a sum probability; and
determining the pixel of interest as a pixel of the foreground object if the sum probability is smaller than a threshold.
